(19) United States
(12) Patent Application Publication
(10) Pub. No.: US 2024/0142765 A1
(43) Pub. Date: May 2, 2024

(54) OPTICAL WAVELENGTH CONVERSION STRUCTURE

(71) Applicant: DELTA ELECTRONICS, INC., Taoyuan City (TW)

(72) Inventors: Po-Tsun KUO, Taoyuan City (TW); Yen-I CHOU, Taoyuan City (TW)

(21) Appl. No.: 18/314,833

(22) Filed: May 10, 2023

Related U.S. Application Data
(60) Provisional application No. 63/381,292, filed on Oct. 28, 2022.

(30) Foreign Application Priority Data
Feb. 3, 2023 (CN) 202310054454.6

(51) Int. Cl. G02B 26/00; G03B 21/20

(52) U.S. Cl. CPC G02B 26/008; G03B 21/204; G03B 21/2066

(57) ABSTRACT

An optical wavelength conversion structure includes a substrate, a reflective layer, an oxide stack layer, and a wavelength conversion layer. The reflective layer is disposed on the substrate. The oxide stack layer is disposed on the reflective layer. The oxide stack layer has a gas barrier index of about 300-1000, and the gas barrier index is defined as

$${\sum }_{i = 1}^{n} {L}_{i} {d}_{i}^{0.5}$$

where L is a thickness, d is a density, and n is a number of layers. The wavelength conversion layer is disposed on the oxide stack layer.

### CROSS-REFERENCE TO RELATED APPLICATION

This application claims priority to U.S. Provisional Application Ser. No. 63/381,292 filed Oct. 28, 2022, and CN application Number No. 202310054454.6, filed Feb. 3, 2023, the disclosures of which are incorporated herein by reference in their entireties.

### BACKGROUND

### Field of Invention

The present invention relates to an optical wavelength conversion structure. More particularly, the present invention relates to an optical wavelength conversion structure with high reliability and stable reflectance.

### Description of Related Art

An optical wavelength conversion structure is an optical transducer that converts a light having a first wavelength into a color light having a second wavelength. Generally, the optical wavelength converter is applied to a spotlight, a car headlight, a monitor, a projector or other special illumination circumstances.

Conventionally, the optical wavelength conversion structure has a phosphor wheel. When a laser light source emits a laser beam to excite a phosphor powder of the phosphor wheel, a color light with a different wavelength is produced. Moreover, as the phosphor wheel is driven to rotate by a motor, different color lights are sequentially produced according to a time sequence. During the high-power operation, the wavelength conversion efficiency of the phosphor wheel is enhanced, and the photoelectric conversion and the lumen output are increased. Consequently, the optical wavelength conversion structure is used in the light source of the new generation projector in recent years.

However, with the increasing demands on the luminance of the projector, the optical power of the laser light for exciting the phosphor powder is high. Consequently, the substrate of the conventional transmission-type optical wavelength conversion structure is very hot. Under this circumstance, the wavelength conversion efficiency of the phosphor powder is reduced, and thus the overall output light is adversely affected. Due to these reasons, the reflection-type optical wavelength conversion structure is the mainstream product in the market.

However, the material of the reflective layer on the substrate in the traditional reflective light wavelength conversion structure has a high activity. Under long-term laser operation and high temperature, this highly activity material is easy to react with external pollution sources (such as sulfur, oxygen and other elements) to form compounds, and even migrate and detach by itself, resulting in the deterioration of the original reflective layer after a period of use.

Accordingly, how to improve the reliability of the reflective layer in the light wavelength conversion structure and maintain the stability of its reflectivity becomes an important issue to be solved by those in the industry.

### SUMMARY

The invention provides an optical wavelength conversion structure in which including a substrate, a reflective layer, an oxide stack layer, and a wavelength conversion layer. The reflective layer is disposed on the substrate. The oxide stack layer is disposed on the reflective layer. The oxide stack layer has a gas barrier index of about 300-1000, and the gas barrier index is defined as

$${\sum }_{i = 1}^{n} {L}_{i} {d}_{i}^{0.5}$$

where L is a thickness, d is a density, and n is a number of layers. The wavelength conversion layer is disposed on the oxide stack layer.

In some embodiments of the present invention, the substrate has an upper surface, the reflective layer is disposed on the upper surface, and the upper surface has an average surface roughness less than 50 nanometer.

In some embodiments of the present invention, the reflective layer comprises at least 50 wt % silver

In some embodiments of the present invention, the reflective layer is a pure silver reflective layer.

In some embodiments of the present invention, the oxide stack layer is a distributed Bragg reflector.

In some embodiments of the present invention, the substrate is an aluminum substrate.

In some embodiments of the present invention, the oxide stack layer completely covers the reflective layer.

In some embodiments of the present invention, the oxide stack layer conformally covers the reflective layer.

In some embodiments of the present invention, a portion of the oxide stack layer extends to contact the substrate.

In some embodiments of the present invention, the oxide stack layer covers multiple sidewalls of the reflective layer.

In some embodiments of the present invention, an orthographic projection area of the wavelength conversion layer on the substrate substantially overlaps an orthographic projection area of the reflective layer on the substrate.

In some embodiments of the present invention, an orthographic projection area of the wavelength conversion layer on the substrate is substantially larger than an orthographic projection area of the reflective layer on the substrate.

In some embodiments of the present invention, a sum of a thickness of the reflective layer and a thickness of the oxide stack layer is a first thickness, an orthographic projection of a region of the wavelength conversion layer on the substrate overlaps an orthographic projection of the reflective layer on the substrate, the region has a second thickness, and the second thickness is greater than 10 times the first thickness and less than 500 times the first thickness.

In some embodiments of the present invention, the wavelength conversion layer completely covers the oxide stack layer.

In some embodiments of the present invention, a portion of the wavelength conversion layer extends to contact the substrate.

In some embodiments of the present invention, the wavelength conversion layer is a wavelength conversion patch, the wavelength conversion patch includes a body and a plurality of phosphors distributed in the body.

In some embodiments of the present invention, the wavelength conversion patch is conformally attached to the oxide stack layer.

In some embodiments of the present invention, an orthographic projection area of the wavelength conversion layer on the substrate is substantially equal to an orthographic projection area of the reflective layer on the substrate, and an orthographic projection area of the oxide stack layer on the substrate is substantially equal to an orthographic projection area of the reflective layer on the substrate.

In some embodiments of the present invention, an orthographic projection area of the wavelength conversion layer on the substrate is substantially equal to an orthographic projection area of the reflective layer on the substrate, and an orthographic projection area of the oxide stack layer on the substrate is substantially larger than an orthographic projection area of the reflective layer on the substrate.

In some embodiments of the present invention, an orthographic projection area of the wavelength conversion layer on the substrate is substantially larger than an orthographic projection area of the oxide stack layer on the substrate, and an orthographic projection area of the oxide stack layer on the substrate is substantially larger than an orthographic projection area of the reflective layer on the substrate.

### BRIEF DESCRIPTION OF THE DRAWINGS

The invention can be more fully understood by reading the following detailed description of the embodiment, with reference made to the accompanying drawings as follows:

FIG. 1 is a cross-sectional view illustrating an optical wavelength conversion structure according to one embodiment of the present invention;

FIG. 2 is a cross-sectional view illustrating an optical wavelength conversion structure according to one embodiment of the present invention;

FIG. 3 is a cross-sectional view illustrating an optical wavelength conversion structure according to one embodiment of the present invention;

FIG. 4 is a cross-sectional view illustrating an optical wavelength conversion structure according to one embodiment of the present invention;

FIG. 5 is a cross-sectional view illustrating an optical wavelength conversion structure according to one embodiment of the present invention;

FIG. 6A is an analysis result diagram of the X-ray reflectometry in embodiment 1 of the present disclosure;

FIG. 6B is an analysis result diagram of the X-ray reflectometry in embodiment 2 of the present disclosure.

### DETAILED DESCRIPTION

It is to be understood that the following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact. In addition, spatially relative terms, for example, “lower,” “upper,” “horizontal,” “vertical,” “above,” “over,” “below,” “beneath,” “up,” “down,” “top,” “bottom,” etc. as well as derivatives thereof (e.g., “horizontally,” “downwardly,” “upwardly,” etc.) are used for ease of the present disclosure of one features relationship to another feature. The spatially relative terms are intended to cover different orientations of the device including the features.

As mentioned above, the reflective layer on the substrate in the traditional reflective light wavelength conversion structure is generally divided into two types of product designs: physical reflective coating and chemical scattering particle coating (for example, nano-titanium dioxide coating). Due to the substantial increase in laser power, the phosphor wheels of some high-brightness laser projectors are limited by the high thermal resistance of the nano-titanium dioxide coating, and then turn to the design of phosphor wheels based on physical reflective coatings. At present, most physical reflective coatings use an Omni-Directional Reflector (ODR) structure with enhanced metal reflective coatings, in which metallic silver is the most widely used as a reflective coating with the best reflectivity and high thermal conductivity. However, due to the high activity of silver atoms, it is easy to react with external moisture and oxygen or sulfide, resulting in a decrease in reliability. For example, when the blue laser excites the fluorescent layer and operates for a period of time, the silver coated on the surface of the substrate will undergo an oxidation reaction, and the oxidation and aggregation of the silver will cause the surface to appear blackened and the reflectivity will decrease, which will greatly reduce the brightness of the phosphor wheel, and even the problem of silver layer falling off occurs.

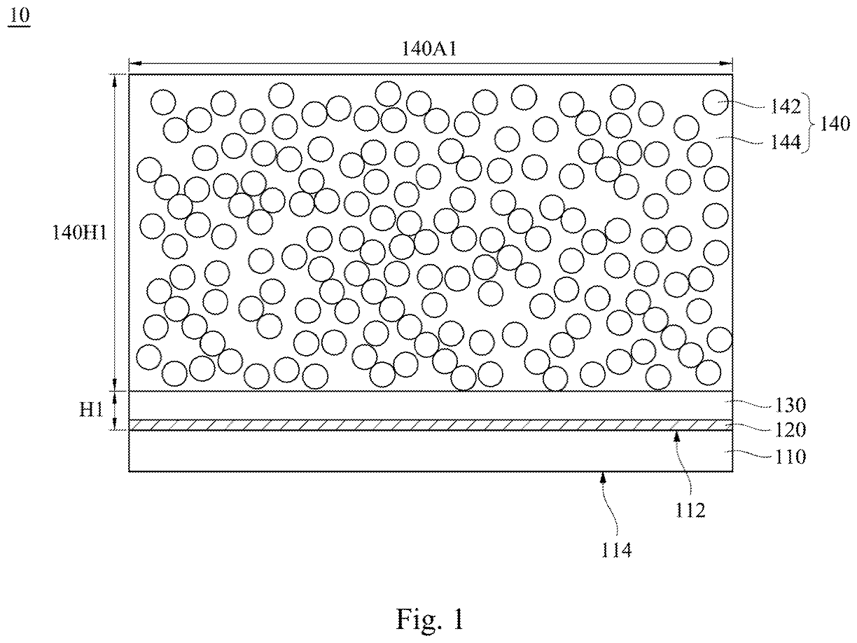

Therefore, the present disclosure provides a design of an optical wavelength conversion structure, which can not only prevent the variation of silver atoms, but also maintain the stability of the reflectance used in the phosphor wheel. FIG. 1 is a cross-sectional view illustrating an optical wavelength conversion structure 10 according to one embodiment of the present invention. As shown in FIG. 1, the optical wavelength conversion structure 10 includes a substrate 110, a reflective layer 120, an oxide stack layer 130, and a wavelength conversion layer 140.

The substrate 110 is a circular substrate in a top view. In some embodiments, the substrate 110 has opposite surfaces, namely an upper surface 112 and a lower surface 114 opposite thereto. It is noted that, an average surface roughness of the upper surface 112 of the substrate 110 should be less than 50 nm so as not to affect a reflective efficiency of the reflective layer 120, which will be described in detail below. In various embodiments, the substrate 110 may be a glass substrate, a borosilicate glass substrate, a silicon substrate, a quartz substrate, an alumina substrate, a sapphire substrate, a calcium fluoride substrate, a silicon carbide substrate, a graphene thermally conductive substrate, a boron nitride substrate, or a substrate including at least one metal material, in which the metal material is aluminum, magnesium, copper, silver or nickel, but not limited thereto. In one embodiment, the substrate 110 is an aluminum substrate. In the embodiment where the substrate 110 is an aluminum substrate, the aluminum substrate has better heat conduction effect and can release heat efficiently.

Referring to FIG. 1, the reflective layer 120 is disposed on the substrate 110. In some embodiments, the reflective layer 120 is disposed on the upper surface 112 of the substrate 110. The reflective layer 120 covers the upper surface 112 of the substrate 110. When the average surface roughness of the upper surface 112 of the substrate 110 is greater than 50 nanometers, the reflective layer 120 formed on the upper surface 112 of the substrate 110 also fluctuates with the fluctuation of the upper surface 112 at the same time, so that the light strikes the roughness of the reflective layer 120 and cause diffuse reflection, thereby affecting the reflection efficiency. In some embodiments, the reflective layer 120 includes at least 50 wt % silver, such as may be 60 wt % silver, 70 wt % silver, 80 wt % silver, 90 wt % silver, or 100 wt % silver. In other words, the reflective layer 120 may further includes other metals (such as platinum) or non-metals (such as silicon) to balance the activity of silver. In one embodiment, the reflective layer 120 is a pure silver reflective layer, that is, the reflective layer 120 includes 100 wt % silver. The reflective layer 120 has a circular pattern in a top view.

In some embodiments, the optical wavelength conversion structure 10 further includes an adhesive layer (not shown) disposed between the substrate 110 and the reflective layer 120. The adhesive layer is used to enhance the bonding force between the substrate 110 and the reflective layer 120.

Referring to FIG. 1, the oxide stack layer 130 is disposed on the reflective layer 120. To be specific, the oxide stack layer 130 has a gas barrier index (GBI) of about 300-1000, and the gas barrier index is defined as

$${\sum }_{i = 1}^{n} {L}_{i} {d}_{i}^{0.5}$$

wherein L is a thickness, d is a density, and n is a number of layers, which will be described in more detail below. For example, the GBI of the oxide stack layer 130 may be 350, 400, 450, 500, 550, 600, 650, 700, 750, 800, 850, 900, or 950. More specifically, the oxide stack layer 130 is mainly used to prevent the external gas from diffusing into the reflective layer 120 and chemically reacting with the silver, so as to prevent the silver element from being oxidized and degraded.

In some embodiments, the oxide stack layer 130 is formed by stacking multiple oxide dielectric films. In some embodiments, the oxide stack layer 130 is a distributed Bragg reflector (DBR). To be specific, the distributed Bragg reflector may be formed by stacking thin films of at least two homogeneous or heterogeneous materials with different refractive indices. In some embodiments, the number of oxide stack layer 130 may be selected according to actual needs. For example, the oxide stack layer 130 includes two sets of the distributed Bragg reflectors or more.

In some embodiments, the oxide stack layer 130 is mostly composed of metal oxides. When oxygen is adsorbed on the oxide stack layer 130 and decomposed into oxygen atoms, these oxygen atoms will change the dissolved oxygen concentration gradient inside the metal oxide and continue to penetrate deeply. Therefore, the gas permeation model can be used to describe the protection capability of the oxide stack layer 130. The present disclosure describes the gas adsorption, dissolution and permeation theory based on the Sievert model of Fickian Diffusion, as shown in the following formula 1. The corrosive gas will first dissociate and adsorb on the surface of the film, and then pass through the dissolved transmittance (F) between each film layer (L), and the gas atomic transmission rate can be expressed by the product of concentration gradient, dissolution rate (S) and diffusion coefficient (D). Formula 1:

$$F = DS \frac{dC}{dL} = \frac{DS}{L} ( \text{?} - {P}_{b}^{n} ) = \frac{\text{?}}{\text{?}} ( \text{?} - {P}_{b 1}^{n} ) = \frac{{D}_{2} {S}_{2}}{{L}_{2}} ( \text{?} - {P}_{b 2}^{n} ) = … = \frac{\text{?}}{\text{?}} ( \text{?} - {P}_{b 1}^{n} ) = \text{?}$$

$$\text{?} \text{indicates text missing or illegible when filed}$$

where F is a dissolution transmittance, D is a diffusion coefficient, S is a dissolution rate, C is a gas concentration, and L is a number of layers. The gas permeation behavior is actually a kind of mass transfer. When the steady state is reached, the transmittance Fi of each layer of oxide dielectric film will be the same. The gas transmission coefficient associated with the gas transmission rate and the concentration gradient between layers is gas conductivity

$$\text{?} ,$$

$$\text{?} \text{indicates text missing or illegible when filed}$$

so the reciprocal of the gas conductivity of each dielectric layer is like “gas resistance”. The gas resistance of the overall oxide stack layer 130 is the sum of the gas resistance of each layer of dielectric oxide layer, which is expressed by formula 2. Formula 2:

$${\sum }_{i = 1}^{n} \frac{\text{?}}{\text{?}} .$$

$$\text{?} \text{indicates text missing or illegible when filed}$$

The overall protection of the oxide stack layer 130 is better as the thickness of the oxide stack layer 130 is thicker, and worse as the diffusion rate (D) and dissolution rate (S) of each layer are higher.

It may be understood that the diffusivity (D) is according to the Arrhenius model,

$${D}_{i} - {D}_{10} exp ( \text{?} ) ,$$

$$\text{?} \text{indicates text missing or illegible when filed}$$

which describes the relationship of temperature change to diffusivity. Generally, the concentration of the corrosive gas environment is not high, so according to Henry's Law, the dissolution rate (S) in formula 2 may be replaced by Henry's dissolution constant (K) at a low concentration. Hence, formula 2 may be rewritten into formula 3. Formula 3:

$${\sum }_{i = 1}^{n} \frac{{L}_{i}}{\text{?} ( \text{?} )} \sim {\sum }_{i = 1}^{n} \frac{{L}_{i}}{\text{?}} ,$$

$$\text{?} \text{indicates text missing or illegible when filed}$$

where K's the dissolution equilibrium constant of corrosive gas atoms. The material with higher molecular weight or density of the dielectric material will have fewer gas adsorption sites under the same unit area. The dissolution equilibrium constant (K′) of corrosive gas atoms is inversely proportional to the m power of the molecular weight (MW) or density (d) of the dielectric layer material, where m is the gas dissociation index. For example, diatomic gas molecules have a gas dissociation index of 0.5 and monatomic gas molecules have a gas dissociation index of 1. Formula 3 may be rewritten into relational formula (4) associated with the molecular weight or density of the stacked oxide layer. Formula 4:

$${\sum }_{i = 1}^{n} {{L}_{i} ( MW or d )}_{i}^{m} .$$

The diatomic gas (such as oxygen) occupies the most in the atmosphere, which is most likely to penetrate the dielectric layer and corrode the reflective layer. Therefore, 0.5 may be put into m and then the gas barrier index (GBI) defined by present disclosure as

$${\sum }_{i = 1}^{n} {L}_{í} {MW}_{i}^{0.5} or {\sum }_{i = 1}^{n} {L}_{í} {d}_{i}^{0.5}$$

may be got.

Please refer to FIG. 1. In some embodiments, the oxide stack layer 130 covers the reflective layer 120 but not covers multiple sidewalls of the reflective layer 120. The oxide stack layer 130 has a circular pattern in a top view. In some embodiments, an orthographic projection area of the oxide stack layer 130 on the substrate 110 is substantially equal to an orthographic projection area of the reflective layer 120 on the substrate 110.

Referring to FIG. 1, the wavelength conversion layer 140 is disposed on the oxide stack layer 130. As shown in FIG. 1, the wavelength conversion layer 140 includes a colloid 144 and a plurality of phosphors 142 distributed in the colloid 144. In one embodiment, the colloid 144 may include organic or inorganic materials. For example, the organic materials include silica gel, epoxy resin, etc., and the inorganic material includes aluminum oxide or aluminum nitride, etc., but not limited thereto. In some embodiments, the phosphors 142 may include aluminate (such as YAG), silicate, nitride or quantum dots, but not limited thereto.

The wavelength conversion layer 140 has a circular pattern in a top view. In some embodiments, an orthographic projection area of the wavelength conversion layer 140 on the substrate 110 substantially overlaps an orthographic projection area of the reflective layer 120 on the substrate 110. In some embodiments, an orthographic projection area of the wavelength conversion layer 140 on the substrate 110 is substantially equal to an orthographic projection area of the reflective layer 120 on the substrate 110. In some embodiments, a sum of a thickness of the reflective layer 120 and a thickness of the oxide stack layer 130 is a first thickness H1, an orthographic projection of a region 140A1 of the wavelength conversion layer 140 on the substrate 110 overlaps an orthographic projection of the reflective layer 120 on the substrate 110, the region 140A1 has a second thickness 140H1, and the second thickness 140H1 is greater than 10 times the first thickness H1 and less than 500 times the first thickness H1. Since the thickness of the wavelength conversion layer 140 is far greater than the sum of the thicknesses of the reflective layer 120 and the oxide stack layer 130, most of the outside gas will be blocked by the wavelength conversion layer 140 first, thereby achieving the effect of preventing the qualitative change of the reflective layer 120.

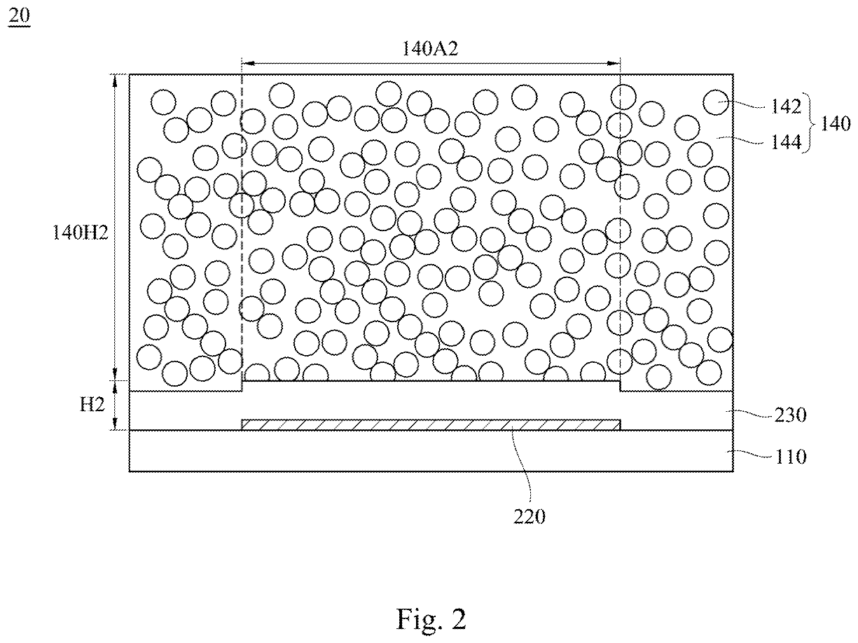

FIG. 2 is a cross-sectional view illustrating an optical wavelength conversion structure 20 according to one embodiment of the present invention. In order to facilitate the comparison with the aforementioned embodiments and simplify the description, the same components are denoted by the same reference numerals in the following examples, and it mainly describes the differences between the various embodiments and no further description is provided for the repeat part.

The optical wavelength conversion structure 20 differs from the optical wavelength conversion structure 10 in that the reflective layer 220 only covers a portion of the substrate 110, the oxide stack layer 230 completely covers the reflective layer 220, and a portion of the oxide stack layer 230 extends to contact the substrate 110. More specifically, the oxide stack layer 230 conformally covers the reflective layer 220. The oxide stack layer 230 not only covers an upper surface of the reflective layer 220 but covers multiple sidewalls of the reflective layer 220. Because the multiple sidewalls of the reflective layer 220 are covered by the oxide stack layer 230, the corrosion probability of the reflective layer 220 by the external gas will be lower.

In some embodiments, an orthographic projection area of the wavelength conversion layer 140 on the substrate 110 is substantially larger than an orthographic projection area of the reflective layer 220 on the substrate 110, and an orthographic projection area of the oxide stack layer 230 on the substrate 110 is substantially larger than an orthographic projection area of the reflective layer 220 on the substrate 110. In some embodiments, a sum of a thickness of the reflective layer 220 and a thickness of the oxide stack layer 230 is a first thickness H2, an orthographic projection of a region 140A2 of the wavelength conversion layer 140 on the substrate 110 overlaps an orthographic projection of the reflective layer 220 on the substrate 110, the region 140A2 has a second thickness 140H2, and the second thickness 140H2 is greater than 10 times the first thickness H2 and less than 500 times the first thickness H2.

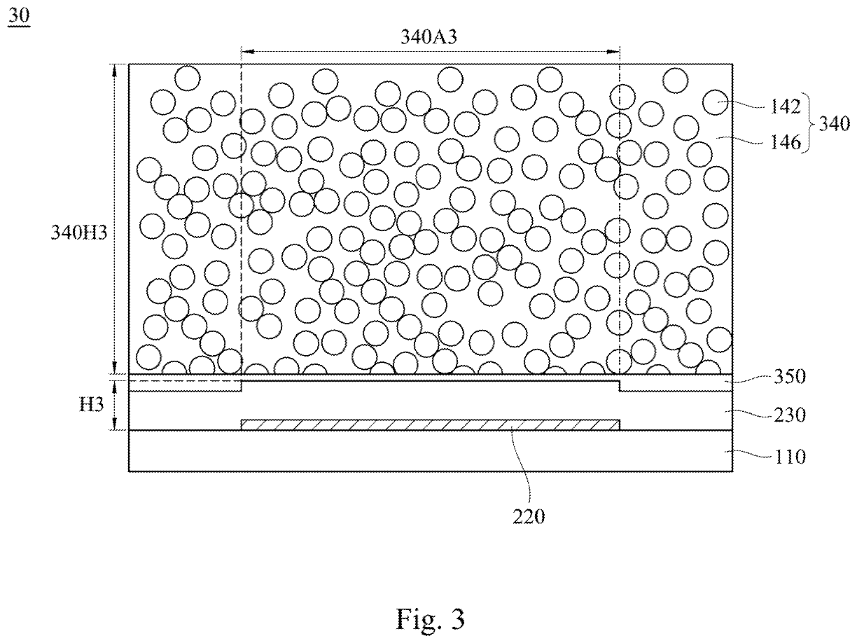

FIG. 3 is a cross-sectional view illustrating an optical wavelength conversion structure 30 according to one embodiment of the present invention. In order to facilitate the comparison with the aforementioned embodiments and simplify the description, the same components are denoted by the same reference numerals in the following examples, and it mainly describes the differences between the various embodiments and no further description is provided for the repeat part.

The optical wavelength conversion structure 30 differs from the optical wavelength conversion structure 20 in that the wavelength conversion layer 340 is a wavelength conversion patch. To be specific, the wavelength conversion patch includes a body 146 and a plurality of phosphors 142 distributed in the body 146. In some embodiments, the body 146 may include organic materials or inorganic materials. For example, the organic materials include silicone, epoxy resin, etc., and the inorganic materials include aluminum oxide, aluminum nitride, etc., but is not limited thereto. In some embodiments, the wavelength conversion patch is attached on the oxide stack layer 230. For example, the wavelength conversion patch may be pasted on the oxide stack layer 230 by using a silica gel 350. It may be understood that the silica gel 350 may fill up gaps on the surface of the oxide stack layer 230. In some embodiments, a sum of a thickness of the reflective layer 220 and a thickness of the oxide stack layer 230 is a first thickness H3, an orthographic projection of a region 340A3 of the wavelength conversion layer 340 on the substrate 110 overlaps an orthographic projection of the reflective layer 220 on the substrate 110, the region 340A3 has a second thickness 340H3, and the second thickness 340H3 is greater than 10 times the first thickness H3 and less than 500 times the first thickness H3.

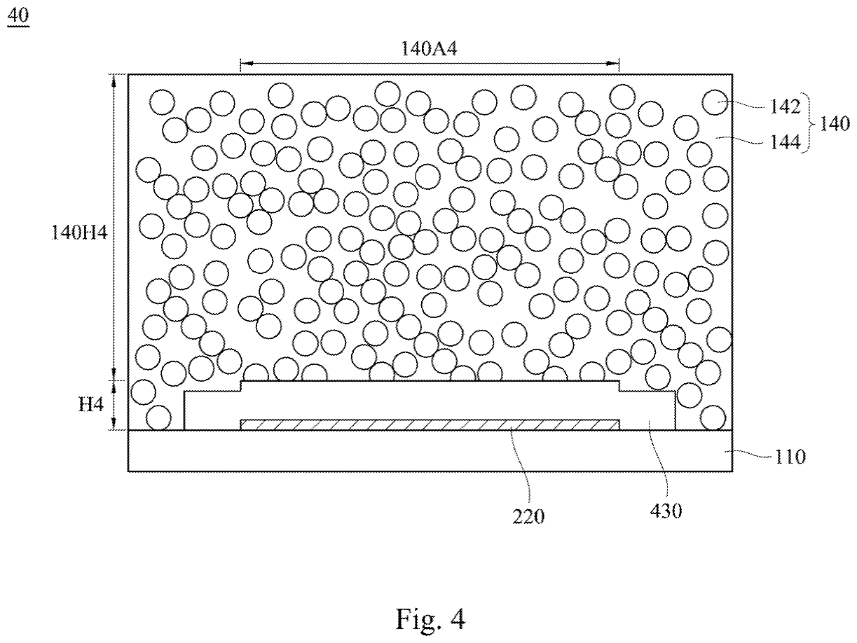

FIG. 4 is a cross-sectional view illustrating an optical wavelength conversion structure 40 according to one embodiment of the present invention. In order to facilitate the comparison with the aforementioned embodiments and simplify the description, the same components are denoted by the same reference numerals in the following examples, and it mainly describes the differences between the various embodiments and no further description is provided for the repeat part.

The optical wavelength conversion structure 40 differs from the optical wavelength conversion structure 20 in that the oxide stack layer 430 completely conformally covers the reflective layer 220 and partially covers the substrate 110, and the wavelength conversion layer 140 completely covers the oxide stack layer 430 and extends to contact the substrate 110. In some embodiments, an orthographic projection area of the wavelength conversion layer 140 on the substrate 110 is substantially larger than an orthographic projection area of the oxide stack layer 430 on the substrate 110, and an orthographic projection area of the oxide stack layer 430 on the substrate 110 is substantially larger than an orthographic projection area of the reflective layer 220 on the substrate 110. In some embodiments, a sum of a thickness of the reflective layer 220 and a thickness of the oxide stack layer 430 is a first thickness H4, an orthographic projection of a region 140A4 of the wavelength conversion layer 140 on the substrate 110 overlaps an orthographic projection of the reflective layer 220 on the substrate 110, the region 140A4 has a second thickness 140H4, and the second thickness 140H4 is greater than 10 times the first thickness H4 and less than 500 times the first thickness H4.

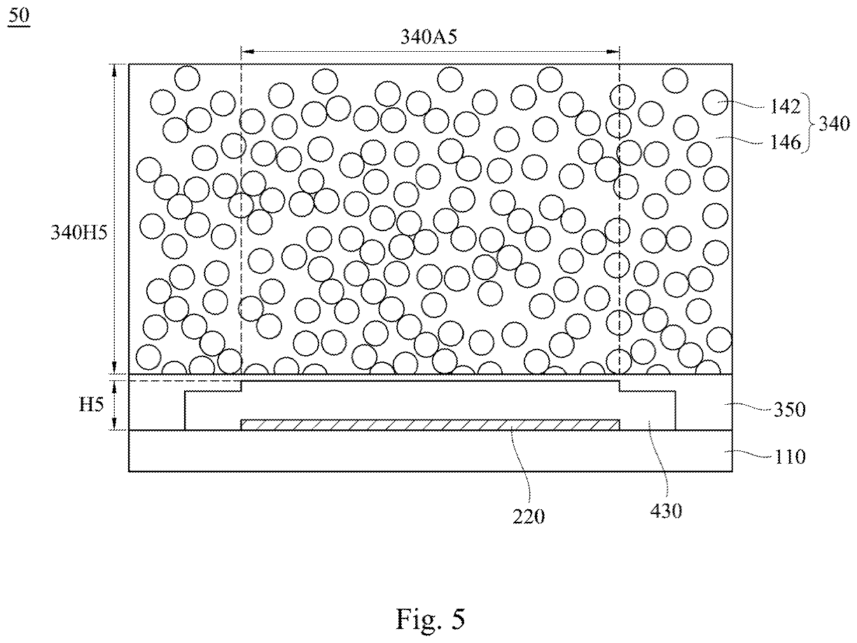

FIG. 5 is a cross-sectional view illustrating an optical wavelength conversion structure 50 according to one embodiment of the present invention. In order to facilitate the comparison with the aforementioned embodiments and simplify the description, the same components are denoted by the same reference numerals in the following examples, and it mainly describes the differences between the various embodiments and no further description is provided for the repeat part.

The optical wavelength conversion structure 50 differs from the optical wavelength conversion structure 40 in that the wavelength conversion layer 340 is a wavelength conversion patch. For example, the wavelength conversion patch may be pasted on the oxide stack layer 430 by using a silica gel 350. It may be understood that the silica gel 350 may fill up gaps on the surface of the oxide stack layer 430. For details about the wavelength conversion patch, please refer to the previous description. In some embodiments, a sum of a thickness of the reflective layer 220 and a thickness of the oxide stack layer 430 is a first thickness H5, an orthographic projection of a region 340A5 of the wavelength conversion layer 340 on the substrate 110 overlaps an orthographic projection of the reflective layer 220 on the substrate 110, the region 340A5 has a second thickness 340H5, and the second thickness 340H5 is greater than 10 times the first thickness H5 and less than 500 times the first thickness H5.

The following Examples are provided to illustrate certain aspects of the present disclosure and to aid those of skill in the art in practicing this disclosure. These Examples are in no way to be considered to limit the scope of the disclosure in any manner.

In the present disclosure, the optical wavelength conversion structures of comparative example 1, embodiment 1 and embodiment 2 will be used to verify the protection of the reflection layer by the GBI range of the oxide stack layer. Comparative example 1, embodiment 1 and embodiment 2 are all tested with the structure shown in FIG. 1. The difference between comparative example 1, embodiment 1 and embodiment 2 is that each of the three has different oxide stacking layers, and the materials and layers of their respective oxide stacking layers are listed in Table 1 below.

TABLE 1

| | | Density | Thickness | |
|---|---|---|---|---|
| | Material | (g/cm3) | (nm) | GBI |
| Comparative | SiO₂ | 2.25 | 37.47 | 182.06 |
| Example 1 | TiO₂ | 3.75 | 64.99 | |
| Embodiment 1 | SiO₂ | 2.25 | 20.23 | 472.78 |
| | TiO₂ | 3.75 | 39.28 | |
| | SiO₂ | 2.4 | 97.13 | |
| | TiO₂ | 3.4 | 46.59 | |
| | SiO₂ | 2.2 | 47.34 | |
| | Al₂O₃ | 4.17 | 20.84 | |
| | InO | 5.7 | 7.21 | |
| Embodiment 2 | SiO₂ | 2.25 | 105.66 | 739.37 |
| | Ta₂O₅ | 7.93 | 49.58 | |
| | SiO₂ | 3.62 | 77.93 | |
| | Ta₂O₅ | 5.28 | 74.11 | |
| | SiO₂ | 3.18 | 61.17 | |
| | InO | 8.12 | 4.78 | |

### Experimental Example 1: Corrosion Test

In this experimental example, the corrosion resistance test of the metal coating was carried out for comparative example 1, embodiment 1 and embodiment 2 by using JIS C60068-2-60:1999, JIS H8502:1999 (tightened 18 times), and JIS H8502:1999 (tightened 1000 times) test standards, and the results are shown in Table 2 below.

TABLE 2

| | | JIS H8502:1999 | JIS H8502:1999 |
|---|---|---|---|
| | JIS C60068-2-60:1999 | (tightened 18 times) | (tightened 1000 times) |
| experimental | H₂S: 0.01 ppm; | H₂S: 1.5 ppm; | H₂S: 15 ppm; |
| condition | O₂: 0.2 ppm; | NO₂: 3.0 ppm; | NO₂: 25 ppm; |
| | Cl₂: 0.01 ppm; | Temperature: 30° C.; | Temperature: 40° C.; |
| | NO2: 0.2 ppm; | Relative humidity: 70%; | Relative humidity: 90%; |
| | Temperature: room | Test days: 4 days | Test days: 10 days |
| | temperature; | | |
| | Relative humidity: 75%; | | |
| | Test days: 14 days | | |
| Comparative | NG | NG | NG |
| Example 1 | | | |
| Embodiment 1 | Pass | Pass | NG |
| Embodiment 2 | Pass | Pass | Pass |

It can be seen from Table 2 above that the test results of comparative example 1 (GBI 182.06) were all failures. The reflectance of comparative example 1 dropped by more than 10% after being tested under JIS C60068-2-60:1999, and the reflective layer of comparative example 1 even peeled off and became unusable after being tested under JIS H8502:1999. The reflectance of embodiment 1 (GBI is 472.78) drops less than 1% after being tested under JIS C60068-2-60:1999, and the reflectance of embodiment 1 drops less than 3% after being tested under JIS H8502:1999 (tightened 18 times). However, the reflective layer of embodiment 1 peeled off and could not be used after being tested under JIS H8502:1999 (tightened 1000 times). If some materials of the oxide stack layer in embodiment 1 are replaced with materials with higher density/molecular weight, as shown in embodiment 2 (GBI is 739.37). Example 2 was successful after all corrosion resistance tests, and the decrease in reflectance was less than 1%. This result shows that the GBI of the oxide stack does have a certain correlation with the corrosion resistance of the reflective layer. To be specific, the higher the GBI of the oxide stack layer, the better the corrosion resistance effect on the reflective layer.

### Experimental Example 2: Density Analysis of the Oxide Stack Layers

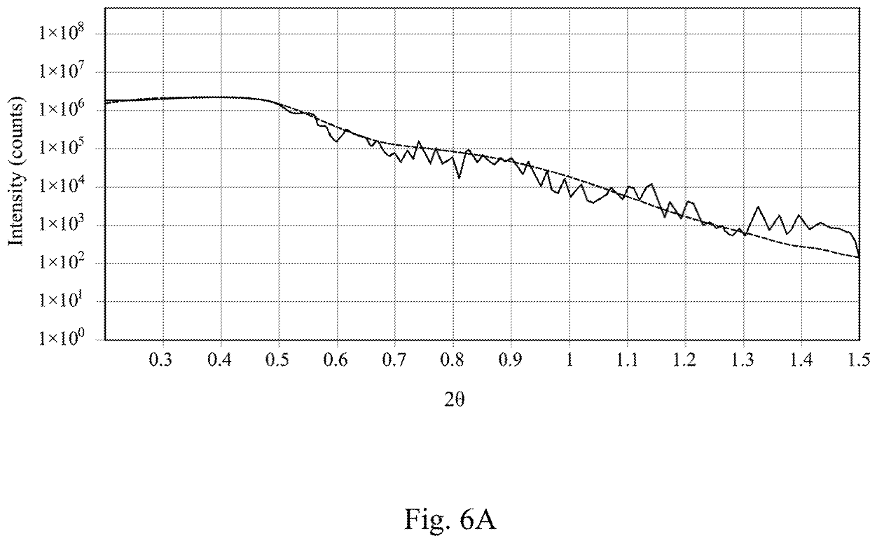

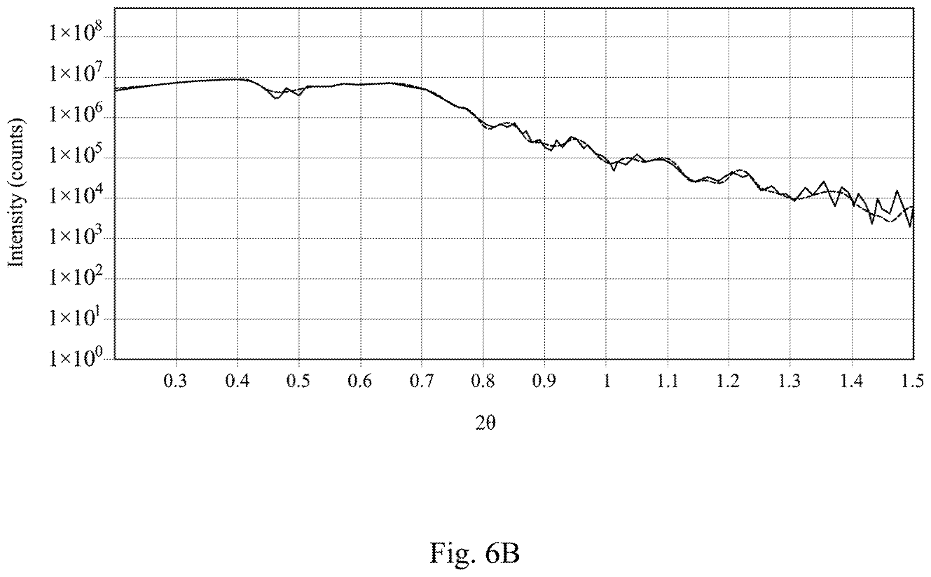

FIG. 6A is an analysis result diagram of the X-ray reflectometry in embodiment 1 of the present disclosure. FIG. 6B is an analysis result diagram of the X-ray reflectometry in embodiment 2 of the present disclosure. In this experimental example, X-Ray Reflectometry (XRR) is used to analyze the overall compactness of the oxide stack layer. To be specific, XRR is the surface reflection measurement of the X-ray light source. When irradiating at a large sweep angle (large incident angle or small 2θ), the X-ray will be totally reflected into the atmosphere. As the incident angle becomes smaller, when X-rays start to hit the surface of the material, the amount of total reflection begins to decrease, and the 2θ reflection signal also begins to decrease, where the level of the 2θ reflection signal means the compactness of the surface film layer, that is to say, the denser the surface film layer, the stronger the protective surface characteristics. The higher the reflection of X-ray photons, the higher the 2θ. It can be seen from FIGS. 6A and 6B that embodiment 2 has a higher 2θ reflection angle value (about 0.65), which is higher than the 2θ reflection angle value (about 0.45) of embodiment 1 with more layers of dielectric layers. In addition, from the fact that the area under the curve of embodiment 2 is larger than the area under the curve of embodiment 1, it can also be known that compared with embodiment 1, the oxide stacked layer in embodiment 2 is denser and has better resistance to gas penetration.

### Experimental Example 3: High Temperature and Aging Test of the Optical Wavelength Conversion Structure

In this experimental example, the light wavelength conversion structure of embodiment 2 was exposed to normal pressure and oxygen-rich environment for high-temperature testing, and it was found that even after baking for 2500 hours at a high temperature of 300° C., the reflectance of embodiment 2 changed only about 6.5%. In addition, the optical wavelength conversion structure of the embodiment 2 is applied to the laser projector aging test, and it is found that the brightness attenuation trend of the embodiment 2 is consistent with the brightness attenuation trend of the non-silvered optical wavelength conversion structure. However, after 5000 hours to 8000 hours of the aging test, the brightness decay rate of the embodiment 2 is significantly smaller than that of the non-silvered light wavelength conversion structure. This shows that the optical wavelength conversion structure with high GBI oxide stack layers is stable and reliable when used in laser projectors.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical wavelength conversion structure, comprising:
a substrate;
a reflective layer disposed on the substrate;
an oxide stack layer disposed on the reflective layer and having a gas barrier index of about 300-1000, and the gas barrier index being defined as
$${\sum }_{i = 1}^{n} {L}_{í} {d}_{i}^{0.5} ,$$
where L is a thickness, d is a density, and n is a number of layers; and
a wavelength conversion layer disposed on the oxide stack layer.

2. The optical wavelength conversion structure of claim 1, wherein the substrate has an upper surface, the reflective layer is disposed on the upper surface, and the upper surface has an average surface roughness less than 50 nanometer.

3. The optical wavelength conversion structure of claim 1, wherein the reflective layer comprises at least 50 wt % silver.

4. The optical wavelength conversion structure of claim 1, wherein the reflective layer is a pure silver reflective layer.

5. The optical wavelength conversion structure of claim 1, wherein the oxide stack layer is a distributed Bragg reflector.

6. The optical wavelength conversion structure of claim 1, wherein the substrate is an aluminum substrate.

7. The optical wavelength conversion structure of claim 1, wherein the oxide stack layer completely covers the reflective layer.

8. The optical wavelength conversion structure of claim 1, wherein the oxide stack layer conformally covers the reflective layer.

9. The optical wavelength conversion structure of claim 8, wherein a portion of the oxide stack layer extends to contact the substrate.

10. The optical wavelength conversion structure of claim 8, wherein the oxide stack layer covers multiple sidewalls of the reflective layer.

11. The optical wavelength conversion structure of claim 1, wherein an orthographic projection area of the wavelength conversion layer on the substrate substantially overlaps an orthographic projection area of the reflective layer on the substrate.

12. The optical wavelength conversion structure of claim 1, wherein an orthographic projection area of the wavelength conversion layer on the substrate is substantially larger than an orthographic projection area of the reflective layer on the substrate.

13. The optical wavelength conversion structure of claim 1, wherein a sum of a thickness of the reflective layer and a thickness of the oxide stack layer is a first thickness, an orthographic projection of a region of the wavelength conversion layer on the substrate overlaps an orthographic projection of the reflective layer on the substrate, the region has a second thickness, and the second thickness is greater than 10 times the first thickness and less than 500 times the first thickness.

14. The optical wavelength conversion structure of claim 1, wherein the wavelength conversion layer completely covers the oxide stack layer.

15. The optical wavelength conversion structure of claim 1, wherein a portion of the wavelength conversion layer extends to contact the substrate.

16. The optical wavelength conversion structure of claim 1, wherein the wavelength conversion layer is a wavelength conversion patch, the wavelength conversion patch comprises a body and a plurality of phosphors distributed in the body.

17. The optical wavelength conversion structure of claim 16, wherein the wavelength conversion patch is conformally attached to the oxide stack layer.

18. The optical wavelength conversion structure of claim 1, wherein an orthographic projection area of the wavelength conversion layer on the substrate is substantially equal to an orthographic projection area of the reflective layer on the substrate, and an orthographic projection area of the oxide stack layer on the substrate is substantially equal to an orthographic projection area of the reflective layer on the substrate.

19. The optical wavelength conversion structure of claim 1, wherein an orthographic projection area of the wavelength conversion layer on the substrate is substantially equal to an orthographic projection area of the reflective layer on the substrate, and an orthographic projection area of the oxide stack layer on the substrate is substantially larger than an orthographic projection area of the reflective layer on the substrate.

20. The optical wavelength conversion structure of claim 1, wherein an orthographic projection area of the wavelength conversion layer on the substrate is substantially larger than an orthographic projection area of the oxide stack layer on the substrate, and an orthographic projection area of the oxide stack layer on the substrate is substantially larger than an orthographic projection area of the reflective layer on the substrate.
